(19) United States
(12) Patent Application Publication
(10) Pub. No.: US 2025/0293772 A1
(43) Pub. Date: Sep. 18, 2025

(54) METHOD FOR ESTABLISHING A CONNECTION WITH AN OPTICAL LINE TERMINATION

(71) Applicant: Alpha Networks Inc., Hsinchu (TW)

(72) Inventors: Chih-Feng CHENG, Hsinchu (TW); Chi-Chien LIU, Hsinchu (TW)

(21) Appl. No.: 18/909,887

(22) Filed: Oct. 8, 2024

(30) Foreign Application Priority Data
Mar. 13, 2024 (TW) 113109164

(51) Int. Cl. H04B 10/077; H04B 10/079

(52) U.S. Cl. CPC H04B 10/0775; H04B 10/0793

(57) ABSTRACT

A method for establishing a connection with an OLT is to be implemented by an ONU that stores a plurality of pre-stored profiles each including a plurality of timing parameters and includes the following steps. The ONU selects a to-be-tested profile from among the pre-stored profiles, generates a registration request and transmits it to the OLT. The ONU determines whether a registration success reply from the OLT is received. If the registration success reply is not received, the ONU determines whether there is any profile among those of the pre-stored profiles that have not been previously selected. If there is a profile among those of the pre-stored profiles that have not been selected, the ONU repeats the steps of selecting the to-be-tested profile and determining whether a registration success reply is received. If the registration success reply is received, the ONU establishes an interoperable connection with the OLT.

### CROSS-REFERENCE TO RELATED APPLICATION

This application claims priority to Taiwanese Invention Patent application Ser. No. 11/310,9164, filed on Mar. 13, 2024, and incorporated by reference herein in its entirety.

### FIELD

The disclosure relates to a method applied in a passive optical network (PON) system, and more particularly to a method for establishing a connection with an optical line termination.

### BACKGROUND

Optical fiber equipment, such as an optical line termination (OLT), an optical network unit (ONU) and various other hardware components, are used in fiber optic communication systems, e.g., a passive optical network (PON) system. In a PON system, normally the OLT and the ONU are produced by different manufacturers. However, in such cases, a problem of interoperability between the OLT and the ONU due to timing intervals between the ONU and the OLT being not synchronized may exist, in which case a connection may not be established between the ONU and the OLT.

A conventional method for resolving the above-mentioned issue of interoperability involves determining the brand or model of the OLT that is to be connected before deploying the ONU. Timing intervals of the ONU are then adjusted according to the specifications of the OLT. However, if the OLT is replaced by a new OLT from a different brand for some reason, and if the originally-deployed ONU is unable to establish a connection with the new OLT, the ONU must either be returned to the equipment provider or a technician needs to be dispatched to the user's place to resolve the connection issue on the spot, leading to increased labor and other costs.

### SUMMARY

Therefore, an object of the disclosure is to provide a method for establishing a connection with an optical line termination (OLT) that can alleviate at least one of the drawbacks of the prior art.

According to the disclosure, the method for establishing a connection with the OLT is to be implemented by an optical network unit (ONU) that stores a plurality of pre-stored profiles each including a plurality of timing parameters, and includes the following steps.

In one step, the ONU selects a to-be-tested profile from among those of the pre-stored profiles that have not been previously tested, generates a registration request based on the to-be-tested profile, and transmits the registration request to the OLT.

In another step, the ONU determines whether a registration success reply from the OLT in response to the registration request is received.

When it is determined that the registration success reply is not received, the ONU determines whether there is any profile among those of the pre-stored profiles that have not been previously selected. If there is a profile among those of the pre-stored profiles that have not been selected, the ONU repeats the steps of selecting the to-be-tested profile and determining whether a registration success reply is received.

When it is determined that the registration success reply is received, the ONU establishes an interoperable connection with the OLT.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating an embodiment of a passive optical network (PON) system according to the disclosure.

FIG. 2 is a flow chart illustrating an embodiment of a timing parameter test procedure of a method for establishing a connection with an optical line termination according to the disclosure.

FIG. 3 is a flow chart illustrating an embodiment of a timing parameter adjustment procedure of the method according to the disclosure.

FIG. 4 is a flow chart illustrating steps of an optical network unit (ONU) obtaining a new test profile.

FIG. 5 is a flow chart illustrating steps of the ONU adjusting a parameter related to a start time of a burst control signal in a first adjusted profile to obtain a second adjusted profile.

FIG. 6 is a flow chart illustrating steps of the ONU modifying the parameter related to the start time of the burst control signal in the second adjusted profile to obtain a modified profile.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

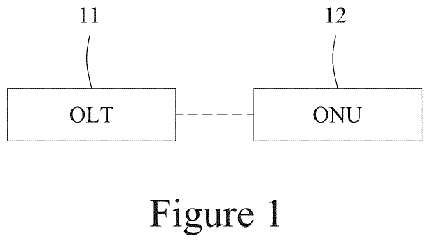

Referring to FIG. 1, an embodiment of a method for establishing a connection with an optical line termination is implemented by an optical network unit (ONU) 12 that is configured to establish a connection with an optical line termination (OLT) 11. In a passive optical network (PON) system, the OLT 11 and the ONU 12 are configured to transmit and process network signals after a connection is established therebetween. In general, the PON system may include one OLT 11 owned by a service provider and a plurality of ONUs 12 owned by different clients (only one is shown in FIG. 1). In FIG. 1, a dashed line indicates a connection to be established between the ONU 12 and the OLT 11.

Various types and models of OLTs are available on the market. In this embodiment, the ONU 12 pre-stores a plurality of profiles corresponding respectively to the various types and models of OLTs (hereinafter referred to as “pre-stored profiles”). Each of the pre-stored profile includes a plurality of parameters related to timing (hereinafter timing parameters) of a burst control signal, such as a start time for the burst control signal (Tx_enable), a stop time for the burst control signal (Tx_disable), a guard time (Tg), a preamble time (Tp), and a delimiter time (Td).

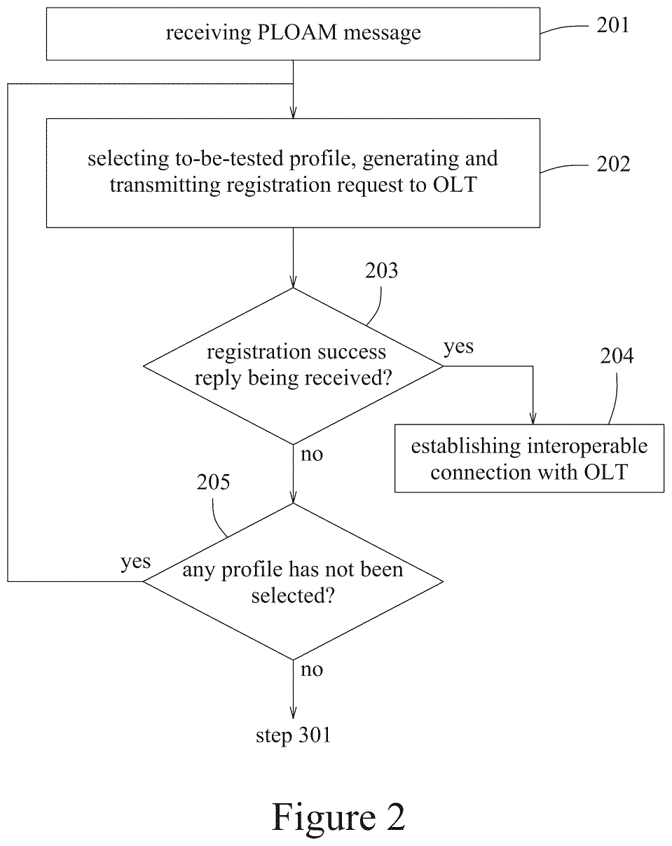

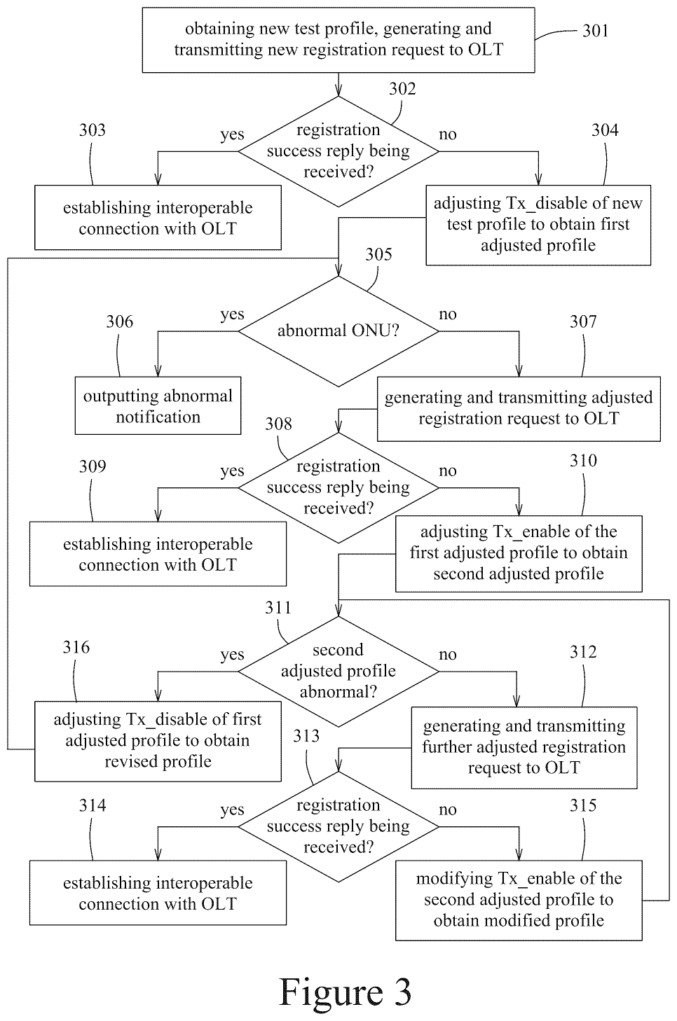

Operation between the ONU 12 and the OLT 11 will be described below. The method for establishing a connection with an optical line termination according to an embodiment of this disclosure includes a timing parameter test procedure 200 (FIG. 2) and a timing parameter adjustment procedure 300 (FIG. 3).

Referring to FIGS. 1 and 2, the timing parameter test procedure 200 of the method is to iteratively test different pre-stored profiles. When necessary, the timing parameter adjustment procedure 300 illustrated in FIG. 3 may be further performed to adjust a chosen profile stored in the ONU 12 to establish an interoperable connection with the OLT 11. The timing parameter test procedure 200 includes steps 201 to 205.

In step 201, the ONU 12 receives a Physical Layer Operations Administration and Maintenance (PLOAM) message from the OLT 11. In this embodiment, the content of the PLOAM message includes, but not limited to, a plurality of network parameters, for example, a delimiter length, a delimiter pattern, a preamble length and the preamble pattern of the OLT 11.

In step 202, the ONU 12 selects a to-be-tested profile from among those of the pre-stored profiles that have not been previously tested, generates a registration request based on the to-be-tested profile, and transmits the registration request to the OLT 11 for an attempt to establish a connection with the OLT 11.

In step 203, the ONU 12 determines whether a registration success

reply from the OLT 11 in response to the registration request is received. When it is determined that the registration success reply is received, the procedure proceeds to step 204; otherwise, the procedure proceeds to step 205.

In step 204, the ONU 12 establishes an interoperable connection with the OLT 11 based on the to-be-tested profile.

In step 205, the ONU 12 determines whether there is any profile among those of the pre-stored profiles that have not been selected in step 202. When it is determined that there is a profile among those of the pre-stored profiles that have not been selected, the process returns to step 202. In this way, by iteratively testing the pre-stored profiles until an interoperable connection is established with the OLT 11, the labor and time costs may be significantly reduced. From the above, it can be seen that in addition to overcoming the disadvantage of the prior art where an ONU must either be returned to the equipment provider or a technician needs to be dispatched to the user's place to resolve the connection issue on the spot, there is also the benefit of not needing to determine the brand of the OLT 11 and set the timing parameters according to the specification of the OLT 11 in advance. Therefore, the convenience of use can indeed be greatly improved. However, when it is determined in step 205 that there is no profile among those of the pre-stored profiles that have not been selected, that is to say, all of the pre-stored profiles have been selected and tested, the process proceeds to the timing parameter adjustment procedure 300.

Referring to FIGS. 1 and 3, the timing parameter adjustment procedure 300 of the method is applied for adjusting one of the pre-stored profiles, so that the interoperable connection between the ONU 12 and the OLT 11 may be established. The timing parameter adjustment procedure 300 includes steps 301 to 316.

In step 301, the ONU 12 obtains a new test profile using at least one of the pre-stored profiles, generates a new registration request based on the new test profile, and transmits the new registration request to the OLT 11 in an attempt to establish a connection with the OLT 11.

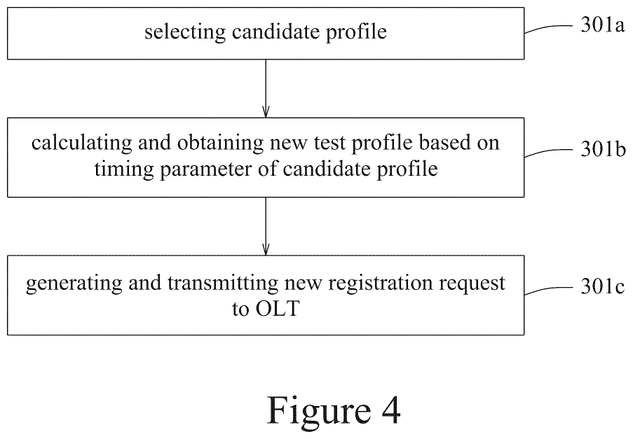

Specifically, step 301 includes the following sub-steps (see FIG. 4).

In step 301a, the ONU 12 selects, from among the pre-stored profiles, at least one candidate profile that supports the preamble length and the delimiter length in the PLOAM message. It should be noted that the following procedure applies when one candidate profile or a plurality of candidate profiles are selected in this step. The following is an example of selecting two candidate profiles.

In step 301b, the ONU 12 calculates and obtains the new test profile

based on the timing parameters of the two candidate profiles. Specifically, each of the candidate profiles includes the timing parameters of the stop time (Tx_disable) and the start time (Tx_enable). In this embodiment, the values of the stop time (Tx_disable) (hereinafter referred to as “Tx_disable value”) respectively of the two candidate profiles are used to calculate the Tx_disable value of the new test profile, and the values of the start time (Tx_enable) (hereinafter referred to as “Tx_enable value”) of the two candidate profiles are used to calculate Tx_enable value of the new test profile. In this embodiment, a method of calculating the Tx_disable value and the Tx_enable value for the new test profile involves taking an average, but it is not limited to this. Specifically, the Tx_disable value for the new test profile is an average of the Tx_disable values of the two candidate profiles, and the Tx_enable value for the new test profile is an average of the Tx_enable values of the two candidate profiles. It is noted that, in the event that only one candidate profile is selected in step 301a, the new test profile will adopt the Tx_disable value of the candidate profile after the calculation in this step.

In step 301c, the ONU 12 generates the new registration request according to the new test profile and transmits the new registration request to the OLT 11.

In step 302, the ONU 12 determines whether a registration success reply from the OLT 11 in response to the new registration request is received. When it is determined that the registration success reply is received, the procedure proceeds to step 303; otherwise, the procedure proceeds to step 304.

In step 303, the ONU 12 establishes an interoperable connection with the OLT 11 based on the new test profile, stores the new test profile, and transmits the new test profile to a database server (not shown) through a communication network, so that the database server may record the new test profile as a profile that is capable of establishing a connection. In this way, more profiles may be added to the database server, and the database server may periodically or operationally updates the pre-stored profiles for other ONUs.

In step 304, the ONU 12 adjusts one of the timing parameters in the new test profile to obtain a first adjusted profile. In this embodiment, the ONU 12 adjusts the Tx_disable value (stop time) of the new test profile. Specifically, the ONU 12 adds a predetermined value, e.g., one, to the Tx_disable value of the new test profile, while assuming the Tx_enable value to be correct and keeping it unchanged, to obtain the first adjusted profile including the Tx_enable value which is unchanged and the Tx_disable value which has been adjusted. It should be noted that the predetermined value indicates a number of pulses to be added to the burst control signal, and adding one to the Tx_disable value means that the stop time is to be postponed by a certain period, i.e., one pulse.

In step 305, the ONU 12 determines whether, after adopting the first adjusted profile, itself is an abnormal (rogue) ONU. Here, the term “abnormal” refers to the Tx_disable value being too large, which means that the stop time is too long, does not help with establishing a connection with the OLT 11, and affects the connections of other ONUs (not shown) with the OLT 11. When the ONU 12 determines that it is an abnormal ONU, the procedure proceeds to step 306, where the ONU 12 outputs an abnormal notification to notify the user that the ONU 12 is abnormal; when the ONU 12 determines that it is not an abnormal ONU, the procedure proceeds to step 307. In this embodiment, the ONU 12 determines whether it is an abnormal ONU by determining whether the Tx_disable value is too large. Specifically, when the Tx_disable value becomes too large (i.e., exceeding a time threshold set by the OLT 11), the OLT 11 generates the abnormal alert to the ONU 12. That is to say, the ONU 12 determines whether it is an abnormal ONU by checking if it receives an abnormal alert from the OLT 11 or not.

In step 307, the ONU 12 generates an adjusted registration request according to the first adjusted profile and transmits the adjusted registration request to the OLT 11.

In step 308, the ONU 12 determines whether a registration success reply from the OLT 11 in response to the adjusted registration request is received. When it is determined that the registration success reply is received, the procedure proceeds to step 309; otherwise, the procedure proceeds to step 310.

In step 309, the ONU 12 establishes an interoperable connection with the OLT 11 based on the first adjusted profile, stores the first adjusted profile, and transmits the first adjusted profile to the database server through the communication network, so that the database server may record the first adjusted profile as another profile that is capable of establishing a connection.

In step 310, the ONU 12 further adjusts another one of the timing parameters of the first adjusted profile by adding a variable to the another one of the timing parameters, so as to obtain a second adjusted profile. In this embodiment, the ONU 12 adjusts the Tx_enable value of the first adjusted profile in step 310; that is to say, the start time of the burst control signal is to be adjusted. A positive value of the variable indicates that the start time of the burst control signal is to be delayed by a total length of one or more pulses, where the quantity of the pulse(s) is equal to the positive value; a negative value of the variable indicates that the start time is to be advanced by a total length of one or more pulses, where the quantity of the pulse(s) is equal to the absolute value of the negative value. It is worth mentioning that, in step 310, the ONU 12 adjusts only the Tx_enable value of the first adjusted profile, and the Tx_disable value, which has been adjusted in step 304, is not changed.

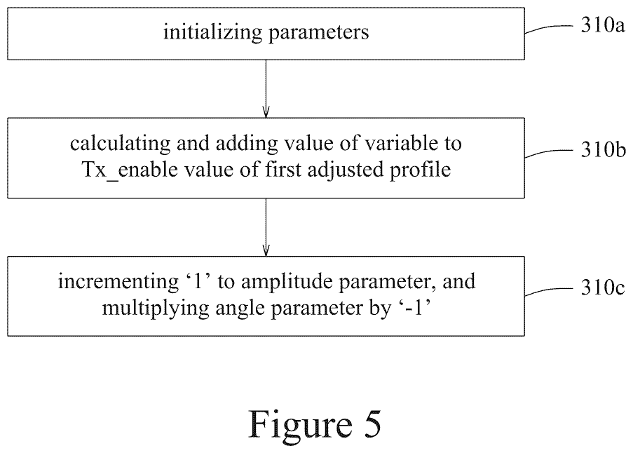

Referring to FIG. 5, in this embodiment, the procedure of obtaining the second adjusted profile in step 310 includes the following sub-steps.

In sub-step 310a, the ONU 12 initializes two parameters to one. Specifically, the two parameters includes an amplitude parameter and an angle parameter, and the ONU 12 initializes a value of each of the amplitude parameter and the angle parameter to one. These two parameters define the variable together.

In sub-step 310b, the ONU 12 calculates the value of the variable to be equal to the product of the values of the amplitude parameter and the angle parameter, and adds the value of variable to the Tx_enable value of the first adjusted profile, to obtain the second adjusted profile.

In sub-step 310c, the ONU 12 increments the value of the amplitude parameter by one, and multiplies the value of the angle parameter by negative one. These two parameters are recorded for later use (when needed).

In step 311, the ONU 12 determines whether the second adjusted profile is abnormal. Specifically, the ONU 12 determines whether the second adjusted profile is abnormal by determining whether a sum of the values of the timing parameters, i.e., Tx_enable, Tx_disable, Tg, Tp and Td (i.e., total time), of the second adjusted profile is greater than a worst case sum time, or the Tx_enable value of the second adjusted profile is less than zero. The worst case sum time is defined in a standard specification document of the PON. When the sum of the values of the timing parameters of the second adjustment profile is not greater than the worst case sum time and the Tx_enable value of the second adjusted profile is not less than zero, the ONU 12 determines that the second adjusted profile is not abnormal, and the procedure proceeds to step 312. However, when the sum of the values of the timing parameters of the second adjusted profile is greater than the worst case sum time or the Tx_enable value of the second adjusted profile is less than zero, the ONU 12 determines that the second adjusted profile is abnormal, the procedure proceeds to step 316.

In step 312, the ONU 12 generates a further adjusted registration request according to the second adjusted profile and transmits the further adjusted registration request to the OLT 11.

In step 313, the ONU 12 determines whether a registration success reply from the OLT 11 in response to the further adjusted registration request is received. When it is determined that the registration success reply is received, the procedure proceeds to step 314; otherwise, the procedure proceeds to step 315.

In step 314, the ONU 12 establishes an interoperable connection with the OLT 11 based on the second adjusted profile, stores the second adjusted profile, and transmits the second adjusted profile to the database server through the communication network, so that the database server may record the second adjusted profile as further another profile that is capable of establishing a connection.

In step 315, the ONU 12 modifies the another one of the timing parameters, i.e., the Tx_enable value, of the second adjusted profile to obtain a modified profile, and returns to step 311 for iterative processing with the modified profile serving as the second adjusted profile.

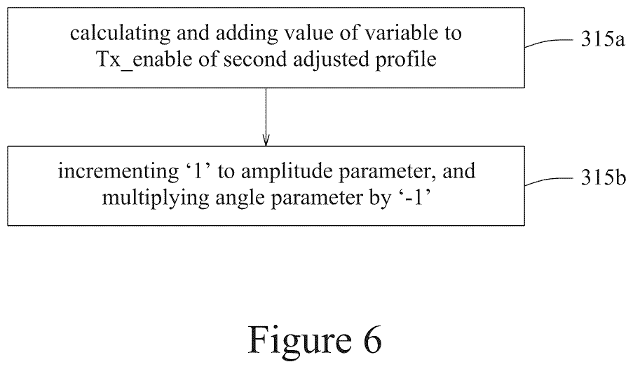

Specifically, in this embodiment, the procedure of modifying the second adjusted profile in step 315 includes the following sub-steps (see FIG. 6).

In sub-step 315a, the ONU 12 adds, to the Tx_enable value of the second adjusted profile, the variable that was obtained in step 310 and that has a value equal to the product of the value of the amplitude parameter and the value of the angle parameter, so as to obtain the modified profile.

In sub-step 315b, the ONU 12 increments the value of the amplitude parameter by one, and multiplies the value of the angle parameter by negative one. These two parameters are recorded for later use (when needed).

After modifying the second adjusted profile, the procedure returns to step 311 with the modified profile serving as the second adjusted profile, and the ONU 12 determines whether the second adjusted profile is abnormal in step 311. When it is determined that the second adjustment profile is abnormal, the procedure proceeds to step 316. In step 316, the ONU 12 adjusts the Tx_disable value of the first adjusted profile, which was obtained in step 304, to obtain a revised profile. In this embodiment, the ONU 12 adds one to the Tx_disable value of the first adjusted profile (similar to step 304), while keeping the Tx_enable value of the first adjusted profile (i.e., the average of Tx_enable values of the two candidate profiles) unchanged. Then, the procedure returns to step 305 with the revised profile obtained in step 316 serving as the first adjusted profile. During the process of adjusting the Tx_disable value (see step 304 and step 316), the ONU 12 gradually increases the Tx_disable value. When the Tx_disable value becomes too large (i.e., exceeding a time threshold set by the OLT 11), the OLT 11 generates the abnormal alert to the ONU 12.

It is worth noting that, in each of step 310 and sub-step 315a, the ONU 12 adds the value of the variable equal to ‘the product of the amplitude parameter and the angle parameter’ to the Tx_enable value of the second adjusted profile. The angle parameter switches between positive one and negative one, thereby causing the Tx_enable value to fluctuate. Since the value added in the previous execution of step 310 or 315a differs by one from the value subtracted in the current execution of this step (e.g., add 1, subtract 2, add 3, subtract 4, and so on), such adjustment is more drastic than if the Tx_enable value is increased or decreased by one each time. This approach allows faster detection of abnormal conditions, while the coverage of the Tx_enable values that are tested during the adjustment process is quite large. On the other hand, if the Tx_disable value is too small, the data received by the ONU 12 from the OLT 11 will be partially lost, thereby resulting in insufficient data or high bit error rate for the ONU 12, which in turn prevents the ONU 12 from connecting to the OLT 11. A sufficiently large Tx_disable value helps the ONU 12 to receive the data completely, thereby allowing the ONU 12 to successfully connect to the OLT 11. However, an excessively large Tx_disable value results in idle pulses. If the Tx_disable value exceeds the time threshold, the ONU 12 will determine that the ONU 12 is abnormal (steps 305 and 306) and cannot be connected to the OLT 11. In addition, since the Tx_disable value obtained in sub-step 301b is the average of the Tx_disable values of the candidate profiles selected from among the pre-stored profiles, it is impossible for the Tx_disable value obtained in sub-step 301b to exceed the time threshold. In the present disclosure, the Tx_disable value is adjusted by adding one in step 304 and step 316; that is to say, the Tx_disable value is incrementally adjusted, thus contributing to the successful connection of the ONU 12 to the OLT 11. By virtue of the timing parameter adjustment procedure 300 shown in FIG. 3, the ONU 12 may automatically adjust/modify the profile to establish an interoperable connection with the OLT 11.

In summary, in the method for establishing a connection with an optical line termination according to the present disclosure, by pre-storing the pre-stored profiles in the ONU 12 and sequentially selecting untested profiles for testing, the ONU 12 may try each of the profiles out to establish a connection with the OLT 11. Furthermore, by modifying the Tx_disable and Tx_enable values to further adjust the profiles, the ONU 12 may automatically adjust its profiles to quickly resolve interoperability issues. This approach saves labor and time costs, thereby achieving the objectives of the present disclosure.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for establishing a connection with an optical line termination (OLT), the method to be implemented by an optical network unit (ONU) that stores a plurality of pre-stored profiles each including a plurality of timing parameters, the method comprising steps:
A) selecting a to-be-tested profile from among those of the pre-stored profiles that have not been previously tested, generating a registration request based on the to-be-tested profile, and transmitting the registration request to the OLT;
B) determining whether a registration success reply from the OLT in response to the registration request is received;
C) in response to determining that the registration success reply is not received, determining whether there is any profile among those of the pre-stored profiles that have not been previously selected;
in response to determining that there is a profile among those of the pre-stored profiles that have not been selected, repeating step A) to step C); and
D) in response to determining that the registration success reply is received, establishing an interoperable connection with the OLT.

2. The method as claimed in claim 1, further comprising, after step C), steps of:
E) in response to determining that there is no profile among the pre-stored profiles has not been selected, obtaining a new test profile using at least one of the pre-stored profiles, generating a new registration request based on the new test profile, and transmitting the new registration request to the OLT;
F) determining whether a registration success reply from the OLT in response to the new registration request is received; and
G) in response to determining that the registration success reply is received, establishing an interoperable connection with the OLT.

3. The method as claimed in claim 2, wherein step E) including sub-steps of:
E1) selecting, from among the pre-stored profiles, at least one candidate profile that supports a preamble length and a delimiter length in a Physical Layer Operations Administration and Maintenance (PLOAM) message received from the OLT;
E2) calculating and obtaining the new test profile according to timing parameters of the at least one candidate profile; and
E3) generating the new registration request according to the new test profile and transmitting the new registration request to the OLT.

4. The method as claimed in claim 3, wherein, in sub-step E1), a plurality of candidate profiles are selected from among the pre-stored profiles, and each of the candidate profiles includes a timing parameter of a stop time for a burst control signal, and a timing parameter of a start time for the burst control signal,
wherein sub-step E2) includes
calculating a value of the stop time for the new test profile by taking an average of the values of the stop time respectively of the candidate profiles, and
calculating a value of the start time for the new test profile by taking an average of the values of the start time respectively of the candidate profiles.

5. The method as claimed in claim 2, further comprising, after step F), steps of:
H) in response to determining that the registration success reply is not received, adjusting one of the timing parameters of the new test profile by adding a predetermined value to the one of the timing parameters, so as to obtain a first adjusted profile;
I) transmitting an adjusted registration request to the OLT according to the first adjusted profile;
J) determining whether a registration success reply from the OLT in response to the adjusted registration request is received; and
K) in response to determining that the registration success reply is received, establishing an interoperable connection with the OLT.

6. The method as claimed in claim 5, further comprising, before step I), steps of:
determining whether the ONU adopting the first adjusted profile is an abnormal ONU;
in response to determining that the ONU is not an abnormal ONU, implementing step I); and
in response to determining that the ONU is an abnormal ONU, outputting an abnormal notification.

7. The method as claimed in claim 6, wherein step H) includes in response to determining that the registration success reply is not received, adjusting a timing parameter of stop time of the new test profile by adding the predetermined value to a value of the stop time, so as to obtain the first adjusted profile; and
wherein the step of determining whether the ONU adopting the first adjusted profile is an abnormal ONU includes determining whether the value of the stop time is too large.

8. The method as claimed in claim 5, further comprising, after step J), steps of:
L) in response to determining that the registration success reply is not received, adjusting another one of the timing parameters of the first adjusted profile by adding aa variable to the another one of the timing parameters, so as to obtain a second adjusted profile;
M) transmitting a further adjusted registration request to the OLT according to the second adjusted profile;
N) determining whether a registration success reply from the OLT in response to the further adjusted registration request is received; and
O) in response to determining that the registration success reply is received, establishing an interoperable connection with the OLT.

9. The method as claimed in claim 8, further comprising, before step M), steps of:
determining whether the second adjusted profile is abnormal;
in response to determining that the second adjusted profile is not abnormal, implementing step M);
in response to determining that the second adjusted profile is abnormal, adjusting that one of the timing parameters, by adding a predetermined value, in the first adjusted profile to obtain a revised profile; and
repeating step I) with the revised profile serving as the first adjusted profile.

10. The method as claimed in claim 9, wherein step L) includes in response to determining that the registration success reply is not received, adjusting a timing parameter of start time of the first adjusted profile by adding the variable thereto, to obtain the second adjusted profile; and
wherein the step of determining whether the second adjusted profile is abnormal includes determining whether a sum of the values of the timing parameters of the second adjusted profile is greater than a worst case sum time, or a value of the timing parameter of start time is less than zero.

11. The method as claimed in claim 9, wherein a value of the variable is equal to a product of a value of an amplitude parameter and a value of an angle parameter, and the value of each of the amplitude parameter and the angle parameter is initialized to one;
after the another one of the timing parameters has been adjusted, before step L), the value of the amplitude parameter is incremented by one, and the value of the angle parameter is multiplied by negative one.

12. The method as claimed in claim 8, further comprising, after step N), a step of:
P) in response to determining that the registration success reply is not received, modifying the another one of the timing parameters of the second adjusted profile to obtain a modified profile, and repeating step M) with the modified profile serving as the second adjusted profile.

13. A method for establishing a connection with an optical line termination (OLT), the method to be implemented by an optical network unit (ONU) that stores a plurality of pre-stored profiles each including a plurality of timing parameters, the method comprising:
obtaining a new test profile using at least one of the pre-stored profiles, generating a new registration request based on the new test profile, and transmitting the new registration request to the OLT;
determining whether a registration success reply from the OLT in response to the new registration request is received; and
in response to determining that the registration success reply is received, establishing an interoperable connection with the OLT.

14. The method as claimed in claim 13, wherein the step of obtaining the new test profile including sub-steps of:
selecting, from among the pre-stored profiles, at least one candidate profile that supports a preamble length and a delimiter length in a Physical Layer Operations Administration and Maintenance (PLOAM) message received from the OLT;
calculating and obtaining the new test profile according to timing parameters of the at least one candidate profile; and
generating the new registration request according to the new test profile and transmitting the new registration request to the OLT.

15. A method for establishing a connection with an optical line termination (OLT), the method to be implemented by an optical network unit (ONU) that stores a plurality of pre-stored profiles each including a plurality of timing parameters, the method comprising:
adjusting one of the timing parameters of a profile obtained based on at least one of the pre-stored profiles by adding a predetermined value to said one of the timing parameters, so as to obtain a first adjusted profile;
transmitting an adjusted registration request to the OLT according to the first adjusted profile;
determining whether a registration success reply from the OLT in response to the adjusted registration request is received; and
in response to determining that the registration success reply is received, establishing an interoperable connection with the OLT.

16. The method as claimed in claim 15, further comprising, after the step of determining whether a registration success reply from the OLT in response to the adjusted registration request is received, a step of:
in response to determining that the registration success reply is not received, adjusting another one of the timing parameters of the first adjusted profile by adding a variable to the another one of the timing parameters, so as to obtain a second adjusted profile;
transmitting a further adjusted registration request to the OLT according to the second adjusted profile;
determining whether a registration success reply from the OLT in response to the further adjusted registration request is received; and
in response to determining that the registration success reply is received, establishing an interoperable connection with the OLT.

17. The method as claimed in claim 16, further comprising, before the step of transmitting the further adjusted registration request to the OLT according to the second adjusted profile, steps of:
determining whether the second adjusted profile is abnormal;
in response to determining that the second adjusted profile is not abnormal, implementing the step of transmitting the further adjusted registration request to the OLT;
in response to determining that the second adjusted profile is abnormal, adjusting that one of the timing parameters, by adding a predetermined value, in the first adjusted profile to obtain a revised profile; and
repeating the step of transmitting the adjusted registration request to the OLT with the revised profile serving as the first adjusted profile.

18. The method as claimed in claim 16, wherein a value of the variable is equal to a product of a value of an amplitude parameter and a value of an angle parameter, and the value of each of the amplitude parameter and the angle parameter is initialized to one;
after the another one of the timing parameters has been adjusted, before step L), the value of the amplitude parameter is incremented by one, and the value of the angle parameter is multiplied by negative one.

19. The method as claimed in claim 16, further comprising, after the step of determining whether a registration success reply from the OLT in response to the further adjusted registration request is received, a step of:
in response to determining that the registration success reply is not received, modifying the another one of the timing parameters of the second adjusted profile to obtain a modified profile, and repeating the step of transmitting a further adjusted registration request to the OLT according to the second adjusted profile with the modified profile serving as the second adjusted profile.

20. The method as claimed in claim 16, wherein that one of the timing parameters of the profile is a stop time for a burst control signal (Tx_disable), and that another one of the timing parameters is a start time for the burst control signal (Tx_enable).
